(19) United States
(12) Patent Application Publication
(10) Pub. No.: US 2015/0194822 A1
(43) Pub. Date: Jul. 9, 2015

(54) Integrated Power Bank

(71) Applicant: Chao-Yu Yueh, Taipei City (TW)

(72) Inventor: Chao-Yu Yueh, Taipei City (TW)

(21) Appl. No.: 14/562,825

(22) Filed: Dec. 8, 2014

(30) Foreign Application Priority Data
Jan. 3, 2014 (TW) 103100126

(51) Int. Cl. H02J 7/00

(52) U.S. Cl. CPC H02J 7/007; H02J 7/0052; H02J 2007/0096; H02J 2007/0062

(57) ABSTRACT

An integrated power bank includes an electric energy stored unit, a power control unit, a first I/O unit, and a second I/O unit. The electric energy stored unit has a battery set. The power control unit is electrically connected to the electric energy stored unit. The first I/O unit is electrically connected to the power control unit, and has a triggered circuit. The triggered circuit is operated on a first mode or a second mode. The second I/O unit is electrically connected to the power control unit, and has a charging protocol circuit and a data protocol circuit. The charger circuit is enabled and the data protocol circuit is disabled when the triggered circuit is operated in the first mode. The charger circuit is disabled and the data protocol circuit is enabled when the triggered circuit is operated in the second mode.

### CROSS-REFERENCES TO RELATED APPLICATIONS

This application claims the benefit of priority based on Taiwan Patent Application No. 103100126, filed on Jan. 3, 2014, the contents of which are incorporated herein by reference in their entirety.

### BACKGROUND

1. Technical Field

The disclosure relates to a power bank, in particularly, to an integrated power bank with charge function and data transmission function.

2. Description of Related Art

A power bank is a portable charger to provide an electric energy to a mobile device when a battery in the mobile device is out of power.

Referring to FIG. 1, at present, a power bank 10 usually has a power line corresponding to a universal serial bus system (USB) standard. The USB power line includes an input terminal 11 and an output terminal 12. The input terminal 11 is electrically connected to a power supply for receiving an electric energy, which is transmitted to a battery of the power bank 10. The output terminal 12 is electrically connected to a mobile device (not shown in figure) so that the electric energy stored in the battery of the power bank 10 can be transferred to a battery of the mobile device.

However, the USB power line of the present power bank 10 is without the data transmission function. User has to prepare an additional USB data transmission line for exchanging the data between the mobile device and other devices (e.g. laptop). Therefore, user needs to remember to carry the power bank and the USB data transmission line when going outside.

It is therefore an important subject of the invention to provide an integrated power bank, which integrates a charging function and a data transmission function with a power bank.

### SUMMARY OF THE INVENTION

In view of the foregoing, present application is to provide an integrated power bank integrating a power line and a data transmission line.

To achieve the above, an integrated power bank includes an electric energy stored unit, a power control unit, a first I/O unit, and a second I/O unit. The electric energy stored unit has a battery. The power control unit is electrically connected to the electric energy stored unit. The first I/O unit is electrically connected to the power control unit, and has a triggered circuit. The triggered circuit is operated on a first mode or a second mode. The second I/O unit is electrically connected to the power control unit, and has a charging protocol circuit and a data protocol circuit. The charging protocol circuit is enabled and the data protocol circuit is disabled when the triggered circuit is operated in the first mode. The charging protocol circuit is disabled and the data protocol circuit is enabled when the triggered circuit is operated in the second mode.

In one embodiment, the first I/O unit and the second I/O unit are operated under the Universal Serial Bus (USB) standard.

In one embodiment, the power control unit includes a charging management circuit, a boost circuit, and a buck circuit. The charging management circuit is electrically connected to the first I/O unit. The boost circuit is electrically connected to the charging management circuit. The buck circuit is electrically connected to the boost circuit and the electric energy stored unit.

In one embodiment, the charging protocol circuit is a voltage dividing circuit or a short circuit.

In one embodiment, the data protocol circuit is a voltage dividing circuit.

As mentioned above, the integrated power bank of the present application utilizes to control the triggered circuit to enable the charging protocol circuit or the data protocol circuit so as to perform a charging function or a data transmission function. The first I/O unit can be connected to a mobile device to charge when the charging protocol circuit is enabled. The data can be transmitted between the first I/O unit and the second I/O unit when the data protocol circuit is enabled, wherein the first I/O unit is electrically connected to a first electric device, and the second I/O unit is electrically connected to a second electric device.

### BRIEF DESCRIPTION OF THE DRAWINGS

The parts in the drawings are not necessarily drawn to scale, the emphasis instead being placed upon clearly illustrating the principles of at least one embodiment. In the drawings, like reference numerals designate corresponding parts throughout the various diagrams, and all the diagrams are schematic.

FIG. 1 is a schematic diagram showing a mobile power bank of a prior art.

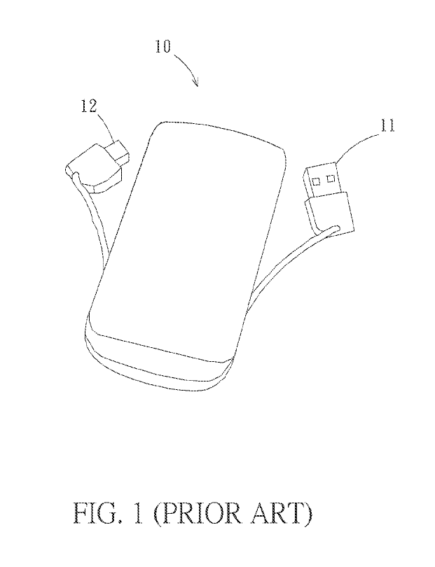

FIG. 2 is a block diagram showing an integrated power bank according to an embodiment of the invention.

FIG. 3 is a circuit diagram showing the integrated power bank according to an embodiment of the invention.

### DETAILED DESCRIPTION

Reference will now be made to the drawings to describe various inventive embodiments of the present disclosure in detail, wherein like numerals refer to like elements throughout.

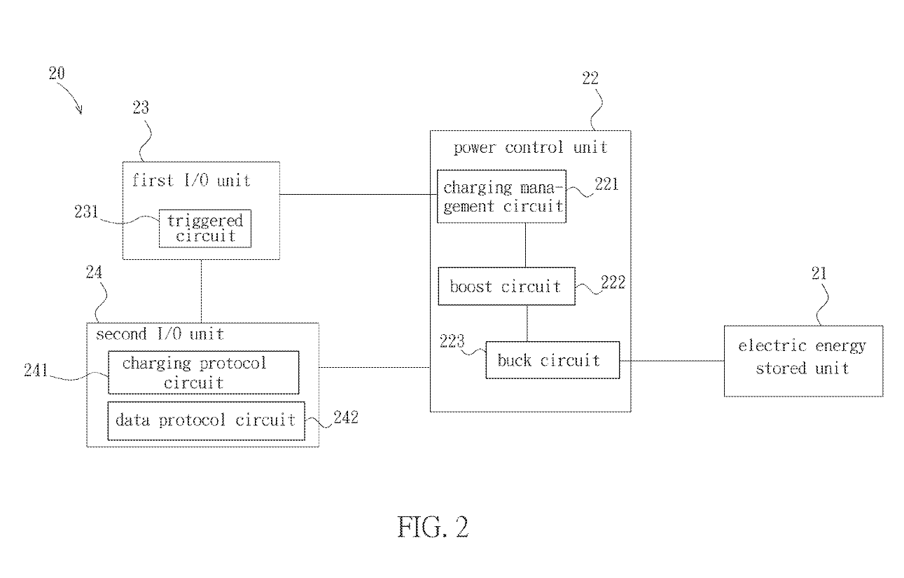

Referring to FIG. 2, an integrated power bank 20 according to an embodiment of the invention includes an electric energy stored unit 21, a power control unit 22, a first I/O unit 23, and a second I/O unit 24.

The electric energy stored unit 21 includes a battery, which is a secondary battery can be charged. In the embodiment, the battery can be a Li-polymer battery or a Li-ion battery.

The power control unit 22 is electrically connected to the electric energy stored unit 21 and includes a charging management circuit 221, a boost circuit 222, and a buck circuit 223. The charging management circuit 221 is electrically connected to the first I/O unit 23. The boost circuit 222 is electrically connected to the charging management circuit 221. The buck circuit 223 is electrically connected to the boost circuit 222 and the electric energy stored circuit 21. The charging management circuit 221 is used for limiting the voltage when the battery is charging or discharging to stable the battery and prolong the lifetime of the battery.

A charging voltage is transferred to a high level voltage by the boost circuit 222, and then transferred to a low level voltage from the high level voltage by the buck circuit 223 so as to provide to the battery for charging.

At present, the Li-ion battery charger utilizes a three-stage charging method, for example, which includes a pre-charging mode, a constant-current (CC) charging mode, and a constant-voltage (CV) charging mode, wherein the CC charging mode and the CV charging mode is so called a normal-charging mode. In general, a state-of-charge check of the battery process has to be performed before charging due to a discharge termination voltage of a Li-ion battery is 2.5 volt (V). In one condition, the lithium ion battery is charged in the normal-charging mode if the voltage is greater than 3V. In other condition, the Li-ion battery is charged in a pre-charging mode if the voltage is less than 3V. In the pre-charging mode, the Li-ion battery is charged by a pre-charging current (about 10 percent of the CC charging current) so as to revert a passivation film dissolved on a depth of discharge state.

The pre-charging mode is finished when the voltage of a Li-ion battery is greater than 3V, and then the normal-charging mode is performed. In the normal-charging mode, the CC charging mode and the CV charging mode is performed sequentially.

Referring to FIG. 2, the first I/O unit 23 having a triggered circuit 231 is electrically connected to the power control unit 22. The triggered circuit 231 is operated on a first mode or a second mode.

The second I/O unit 24 having a charging protocol circuit 241 and a data protocol circuit 242 is electrically connected to the first I/O unit 23 and the power control unit 22. The charging protocol circuit 241 is enabled and the data protocol circuit 242 is disabled when the triggered circuit 231 operated in the first mode. The charging protocol circuit 241 is disabled and the data protocol circuit 242 is enabled when the triggered circuit 231 operated in the second mode.

In other word, the integrated power bank 20 is charged when the triggered circuit 231 is operated in the first mode. In the first mode, an electric energy can be provided by a power supply to the electric energy stored unit 21 through the first I/O unit 23. In addition, in the first mode, a mobile device electrically connected to the second I/O unit 24 can be charged by the electric energy stored unit 21. The integrated power bank 20 is operated in a data transmission mode when the triggered circuit 231 is operated in the second mode. In the second mode, the first I/O unit 23 is electrically connected to a first electronic device, and the second I/O unit 24 is electrically connected to a second electronic device. The data is transmitted between the first electronic device and the second electronic device through the first I/O unit 23 and the second I/O unit 24.

In the embodiment, the first I/O unit and the second I/O unit are operated under the Universal Serial Bus (USB) standard.

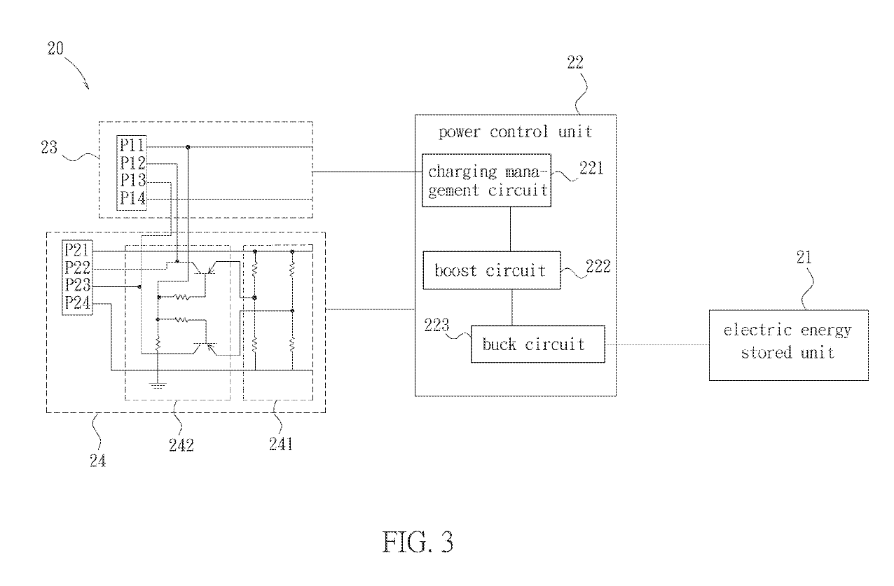

Referring to FIG. 3, the first I/O unit 23 has a first connector having four pins P11, P12, P13, and P14, and the second I/O unit 24 has a second connector having four pins P21, P22, P23, and P24, wherein the pins P11 and P14 are consisted of the triggered circuit 231. In the embodiment, the triggered circuit 231 is operated in the first mode when a voltage is not provided to the pins P11, and P14, and the triggered circuit 231 is operated in the second mode when the voltage is provided to the pins P11, and P14.

In the embodiment, the charging protocol circuit 241 and the data protocol circuit 242 are a voltage dividing circuit, respectively. The dividing voltage of the charging protocol circuit 241 is different to the dividing voltage of the data protocol circuit 242 so that one of the charging protocol circuit 241 and the data protocol circuit 242 can be enabled by the triggered circuit 231.

In other embodiment, the charging protocol circuit 241 can be a short circuit dependent on the different electronic devices.

As mentioned above, the integrated power bank of the present application utilizes to controlling the triggered circuit to enable the charging protocol circuit or the data protocol circuit so as to perform a charging function or a data transmission function. The first I/O unit can be connected to a mobile device to charge when the charging protocol circuit is enabled. The data can be transmitted between the first I/O unit to and the second I/O unit when the data protocol circuit is enabled, wherein the first I/O unit is electrically connected to a first electric device, and the second I/O unit is electrically connected to a second electric device.

Even though numerous characteristics and advantages of certain inventive embodiments have been set out in the foregoing description, together with details of the structures and functions of the embodiments, the disclosure is illustrative only. Changes may be made in detail, especially in matters of arrangement of parts, within the principles of the present disclosure to the full extent indicated by the broad general meaning of the terms in which the appended claims are expressed.

What is claimed is:

1. An integrated power bank, comprising:
a electric energy stored unit;
a power control unit electrically connected to the electric energy stored unit;
a first I/O unit electrically connected to the power control unit and having a triggered circuit operated in a first mode or a second mode; and
a second I/O unit electrically connected to the first I/O unit and the power control unit, and having a charging protocol circuit and a data protocol circuit;
wherein the charging protocol circuit is enabled and the data protocol circuit is disabled by the triggered circuit in the first mode, and the charging protocol circuit is disabled and the data protocol circuit is enabled by the triggered circuit in the second mode.

2. The integrated power bank of claim 1, wherein the electric energy stored unit comprises a battery pack.

3. The integrated power bank of claim 1, wherein the first I/O unit and the second I/O unit are operated under Universal Serial Bus (USB) standard.

4. The integrated power bank of claim 1, wherein the power control unit comprising:
a charging management circuit electrically connected to the first I/O unit;
a boost circuit electrically connected to the charging management circuit; and
a buck circuit electrically connected to the boost circuit and the electric energy stored unit.

5. The integrated power bank of claim 1, wherein the charging protocol circuit or the data protocol circuit is a voltage dividing circuit.

6. The integrated power bank of claim 1, wherein the charging protocol circuit is a short circuit.
